(19) United States
(12) Patent Application Publication
(10) Pub. No.: US 2008/0296445 A1
(43) Pub. Date: Dec. 4, 2008

(54) RETENTION DEVICE

(75) Inventors: Jason DURFEE, Troy, MI (US); Scott Torok, Allen Park, MI (US); Richard Browne, Canton, MI (US)

Correspondence Address: FOLEY AND LARDNER LLP;SUITE 500, 3000 K STREET NW, WASHINGTON, DC, 20007, US

(73) Assignee: BEHR AMERICA, INC.

(21) Appl. No.: 12/113,850

(22) Filed: May 1, 2008

Related U.S. Application Data
(60) Provisional application No. 60/924,165, filed on May 2, 2007.

(51) Int. Cl. F16L 3/08

(52) U.S. Cl. 248/74.2

(57) ABSTRACT

A retention device for coupling a wire harness to an HVAC module comprises a retention clip coupled to the wire harness, the retention clip having an inner surface, an outer surface, and a first channel disposed within the inner surface. A stud may be coupled to the HVAC module. The stud may comprise a first projection, a second projection opposing the first projection, the first and second projections disposed distal to the second component, and a recess disposed between the first projection and the second projection. One or both of the first projection and the second projection may be configured to engage the channel when the stud is received within the retention clip.

### CROSS REFERENCE TO RELATED APPLICATIONS

The present application claims benefit of priority to U.S. Provisional Application Ser. No. 60/924,165, filed May 2, 2007, the entire contents of which is incorporated herein by reference.

### BACKGROUND

The present application relates generally to the field of retention devices. In particular, the application relates to a retention device for wire harnesses.

Heating, ventilation and air conditioning (HVAC) systems include electrical components that must be coupled to power sources and/or controllers. In automotive applications, an HVAC system may include an HVAC module including components such as evaporators, condensers, temperature doors, actuators, blower motors, and other electronic devices. These devices may be formed with ducting and other HVAC components to provide a module that may be installed in a vehicle. These modules must also provide electrical coupling, such as wires, for the electronic devices.

To restrict the movement of loose wires, the wires may be bound together in a bundle by use of a wire harness. The wire harness may be a molded conduit, ties, zip strips, tape or other device that can bundle the wires. The bundled wires may then be connected to the HVAC module and the electronic devices. The bundled wires may be connected to the HVAC module by additional fasteners such as ties or zip strips. However, use of these fasteners may be cumbersome and time consuming when assembling the HVAC module. In particular, attaching the wire harness to the HVAC at the first of several points may be difficult as the wire harness is free to move relative to the HVAC module. Accordingly, it would be desirable to provide an apparatus for quickly and easily attaching a wire harness to an HVAC module.

### SUMMARY

One embodiment relates to a retention device for coupling a first component to a second component comprising a retention clip coupled to the first component, the retention clip having an inner surface, an outer surface, and a first channel disposed within the inner surface; and a stud coupled to the second component, the stud comprising a first projection, and a second projection opposing the first projection. One or both of the first projection and the second projection is configured to engage the channel when the stud is received within the retention clip. According to a variant of this embodiment, the first and second projections may be disposed distal to the second component.

According to yet another variant of this embodiment, a recess may be disposed between the first projection and the second projection.

Another embodiment relates to an HVAC module having a wire harness comprising a retention clip coupled to the first component, the retention clip having an inner surface, an outer surface, and a first channel disposed within the inner surface, and a stud coupled to the second component, the stud comprising a first projection, a second projection opposing the first projection, the first and second projections disposed distal to the second component, and a recess disposed between the first projection and the second projection. One or both of the first projection and the second projection is configured to engage the channel when the stud is received within the retention clip, one of the first component and the second component is a wire harness, and the other of the first component and the second component is an HVAC module.

According to a variant of this embodiment, the first and second projections may be disposed distal to the second component.

According to yet another variant of this embodiment, a recess may be disposed between the first projection and the second projection.

Yet another embodiment relates to a method of assembling an HVAC module for a vehicle. The method may comprise coupling a wire harness to a retention clip having an inner surface, an outer surface, and a first channel disposed within the inner surface; and disposing the retention clip over a stud coupled to the HVAC module, the stud comprising a first projection, and a second projection opposing the first projection.

According to a variant of this embodiment, the first and second projections may be disposed distal to the second component.

According to yet another variant of this embodiment, a recess may be disposed between the first projection and the second projection.

Further objects, features and advantages of the present invention will become apparent from the detailed description of preferred embodiments that follows, when considered together with the accompanying figures of drawing.

### BRIEF DESCRIPTION OF THE DRAWINGS

FIG. 1 is a perspective view of an HVAC module.

FIG. 2 is a perspective view of an HVAC module.

FIG. 3 is a perspective view of a retention device.

FIG. 4 is a perspective view of a retention device.

FIG. 5 is a perspective view of a portion of a retention device.

FIG. 6 is an elevation view of the portion of a retention device shown in FIG. 5.

FIG. 7 is a cross sectional view of the retention device of FIG. 3.

### DETAILED DESCRIPTION OF THE PREFERRED EMBODIMENTS

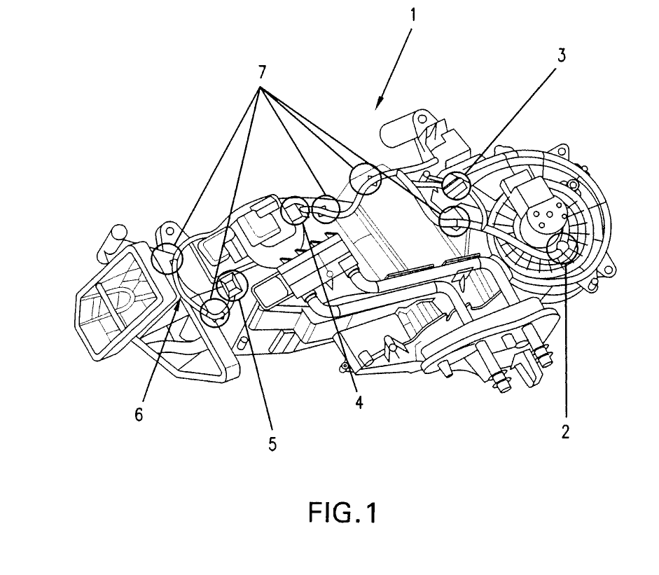

FIG. 1 illustrates an automotive HVAC module (1) according to one embodiment of the present system. The module includes blower motor (2), blower resistor (3), temperature door (with an actuator) (4), and a mode door actuator (5). These electronic components may be electrically coupled to a power supply and/or controllers by wires housed within a wire harness (shown as a flexible conduit).

The wire harness (6) is fixed, according to the particular embodiment shown, at five or more points (7). The wire harness (6) is thereby restricted in its movement relative to the rest of the HVAC module (1).

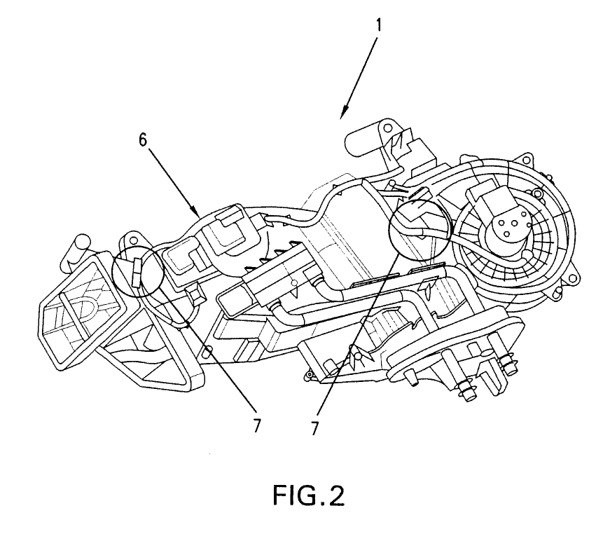

FIG. 2 illustrates the HVAC module of FIG. 1. In some embodiments, the retention device as disclosed herein may be used to secure the wire harness (6) to the HVAC module (1) at all of the fixing points (7). In other embodiments, the retention device may be used at only a portion of the fixing points (7) to facilitate assembly, while using fastening devices, such as ties, zip strips or tape, at other points (7). The use of these fastening devices at the other fixing points (7) may reduce overall costs while not substantially increasing assembly time or complexity.

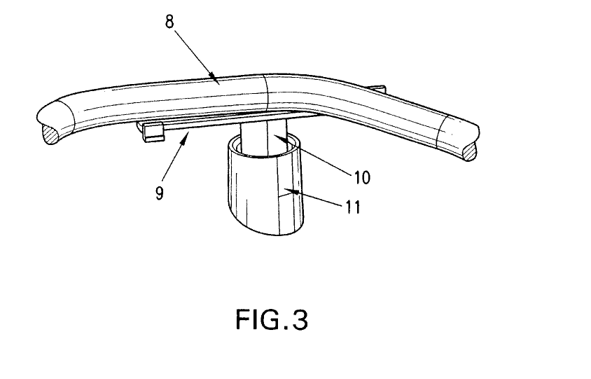

FIG. 3 illustrates a retention device. A wire harness (8) may be coupled to a harness holder (9) by fastening devices such as ties, tape, or zip strips. The harness holder (9) is in turn coupled to a retention clip (10) that is received in a collar (11).

In some embodiments, the retention clip may be formed as a single unitary body with the harness holder (e.g., as a single molded part). In other embodiments, the harness holder and the retention may be separate parts that are coupled together.

The collar may be formed as an integral part of the HVAC module, for example, as a molded portion of the HVAC module. In other embodiments, the collar and HVAC module housing may both comprise a plastic material and be coupled by fasteners, adhesive, ultrasonic welding, or other suitable method of attachment.

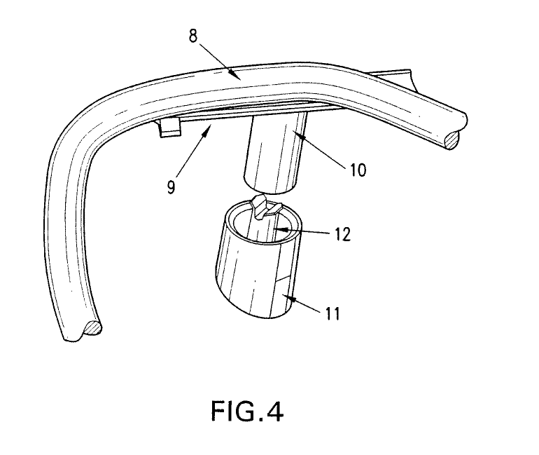

FIG. 4 illustrates the retention device of FIG. 3, with the retention clip (10) removed from the collar (11). A stud (12) is disposed within and generally concentrically with the collar (11) for coupling the retention clip (10) within the collar (11). When assembled, the retention clip (10) is received within the collar (11), and the stud (12) is received within the retention clip (10).

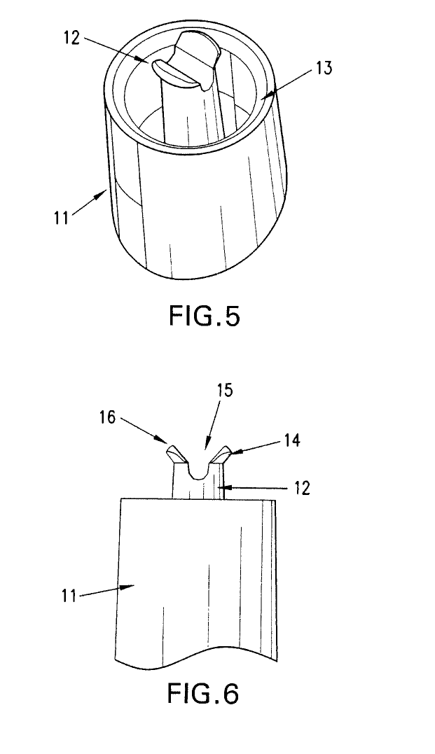

FIGS. 5 and 6 show the collar of FIGS. 3 and 4 in more detail. The collar (11) includes a collar guide surface (13) about its inside surface. The guide surface (13) is angled to direct the retention clip (shown in FIG. 4) into the collar (11). The stud (12) may include two projections (14) that are on opposite sides of the stud (12). The projections (14) extend outwardly in relation to one another. Additionally, the stud (12) may include a recess (15) or space disposed between the projections (14). The recess (15) allows the projections (14) to be flexed inwardly towards one another when the stud (12) is received in the retention clip (10). In some embodiments, each of the projections (14) includes a projection guide surface (16) configured to interact with the retention clip to facilitate coupling of the retention clip and collar.

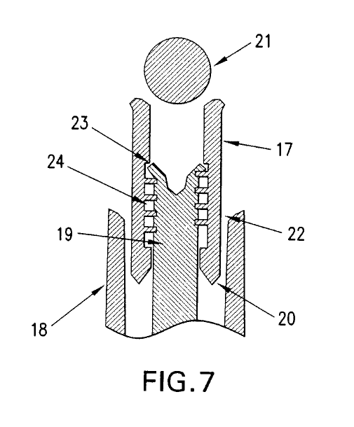

FIG. 7 illustrates an assembled retention device. The retention clip (17) is received within the collar (18) and the stud (19) is received within the retention clip (17). The retention clip (17) may be provided with clip guide surfaces (20) at an end distal to the wire harness (21). The clip guide surfaces (20) may be angled and are configured to interact with the collar guide surface (22) and projection guide surfaces (23), to direct the retention clip (17) into a seated position.

The retention clip (17) may also be provided with a number of channels (24) that are formed on the inside surface of the clip (17). In the embodiment shown, the channels (24) provided on one side of the clip (17) may be offset relative to the channels (17) on the opposing side of the clip (17). This configuration allows the retention clip (17) to be seated on the stud (19) while reducing the total deflection of the projections required to move each channel over the projections. Alternatively, the channels may be formed as a series of concentric circular channels in the inside surface of the retention clip, or any other configuration that produces a sufficient holding force by interaction with the projections.

The shape of the stud, collar, and retention clip may be selected in order to reduce manufacturing costs. In particular the shape of the stud and angle of the guide surfaces may be selected to optimize mold release when the collar and stud are co-molded with the HVAC module.

A wire harness may be coupled to an HVAC module by a variety of methods using the retention device disclosed herein. In one such method, the wire harness may be coupled to the harness holder at a predetermined distance from the end of the wire harness. This coupling may be done with tape, zip strips, ties, or other suitable device or method. The distance from the end of the wire harness will depend on the specific vehicle application.

The harness holder may be coupled to a retention clip, or the harness holder and retention clip may be formed as a single unitary body by, for example, being molded as a single part. After the wire harness is attached to the harness holder, the retention clip may be pushed into a collar such that the retention clip is engaged by a stud.

Once the wire harness has been secured at a single position, it may be further secured at additional positions using the same or similar retention device, or fastening devices including tape, ties, zip strips, adhesives, or other attachment devices and methods. Once the wire harness is secured to the HVAC module, the wires may be coupled to the various electronic devices. Alternatively, the wires may be coupled to the electronic devices before the wire harness is secured to the HVAC modules.

Although the foregoing has been described with reference to exemplary embodiments, workers skilled in the art will recognize that changes may be made in form and detail without departing from the spirit and scope thereof. For example, although different example embodiments may have been described as including one or more features providing one or more benefits, it is contemplated that the described features may be interchanged with one another or alternatively be combined with one another in the described example embodiments or in other alternative embodiments. The present subject matter described with reference to the example embodiments and set forth in the following claims is manifestly intended to be as broad as possible. For example, unless specifically otherwise noted, the claims reciting a single particular element also encompass a plurality of such particular elements. Many other changes and modifications may be made to the present invention without departing from the spirit thereof. The scope of these and other changes will become apparent from the appended claims. The steps of the methods described herein may be varied, and carried out in different sequences.

What is claimed is:

1. A retention device for coupling a first component to a second component comprising:
a retention clip coupled to the first component, the retention clip having an inner surface, an outer surface, and a first channel disposed within the inner surface; and
a stud coupled to the second component, the stud comprising a first projection, and a second projection opposing the first projection,
wherein one or both of the first projection and the second projection is configured to engage the channel when the stud is received within the retention clip.

2. The retention device of claim 1, wherein the first and second projections are disposed distal to the second component.

3. The retention device of claim 1, wherein a recess is disposed between the first projection and the second projection.

4. The retention device of claim 1, wherein one of the first component and the second component is a wire harness, and the other of the first component and the second component is an HVAC module.

5. The retention device of claim 1, further comprising a collar extending about the stud.

6. The retention device of claim 5, wherein the collar is concentric with the stud, and the collar includes an angled surface on the interior of the collar at a point distal to the second component.

7. The retention device of claim 1, further comprising an additional channel disposed within the inner surface of the retention clip and on an opposing side of the inner surface; wherein the additional channel is laterally offset from the first channel.

8. An HVAC module having a wire harness comprising:
a retention clip coupled to the first component, the retention clip having an inner surface, an outer surface, and a first channel disposed within the inner surface;
a stud coupled to the second component, the stud comprising a first projection, and a second projection opposing the first projection, and
wherein one or both of the first projection and the second projection is configured to engage the channel when the stud is received within the retention clip, one of the first component and the second component is a wire harness, and the other of the first component and the second component is an HVAC module.

9. The retention device of claim 8, wherein the first and second projections are disposed distal to the second component.

10. The retention device of claim 8, wherein a recess is disposed between the first projection and the second projection.

11. A method of assembling an HVAC module for a vehicle comprising:
coupling a wire harness to a retention clip having an inner surface, an outer surface, and a first channel disposed within the inner surface; and
disposing the retention clip over a stud coupled to the HVAC module, the stud comprising a first projection, and a second projection opposing the first projection.

12. The method according to claim 11, wherein the first and second projections are disposed distal to the second component.

13. The method according to claim 11, wherein a recess is disposed between the first projection and the second projection.
